(19) United States
(12) Patent Application Publication
(10) Pub. No.: US 2015/0379512 A1
(43) Pub. Date: Dec. 31, 2015

(54) COMMUNICATION DURING PAYMENT PROCEDURE

(71) Applicant: OP-PALVELUT OY, Helsinki (FI)

(72) Inventors: Kristian LUOMA, Helsinki (FI); Tuomas JOMPPANEN, Helsinki (FI); Jussi JUNTUNEN, Helsinki (FI)

(21) Appl. No.: 14/768,598

(22) PCT Filed: Feb. 19, 2014
(86) PCT No.: PCT/FI2014/050122

§ 371 Date: Aug. 18, 2015

(30) Foreign Application Priority Data
Feb. 22, 2013 (FI) 20135164

(51) Int. Cl. G06Q 20/40; G06Q 20/12; H04L 29/06

(52) U.S. Cl. CPC G06Q 20/401; H04L 63/08; G06Q 20/12

(57) ABSTRACT

Apparatus and method are provided. The solution includes obtaining (404) from a computing device in a wireless manner information on an identifier related to a purchase session maintained by the computing device; transmitting (406) the identifier to a first network server; receiving (408) information from the first network server, the information related to the purchase session and including a request to acknowledge a purchase of the purchase session; transmitting (410) a purchase acknowledgement to the first network server.

### FIELD

The exemplary and non-limiting embodiments of the invention relate generally to communication during a payment procedure.

### BACKGROUND

The emerging electronic media and mobile computing offer new possibilities in the communication between a consumer and retailers. Shopping via Internet has become more and more popular. The customers may browse the assortments of network stores easily and the purchased items are typically delivered by mail or downloaded directly. Payments are typically realized with credit cards. However, there is a need to more simple yet reliable payment methods.

### SUMMARY

The present invention seeks to provide an improved solution for validating payments.

According to an aspect of the present invention, there is provided an apparatus, comprising: at least one processor; at least one memory including computer program code; the at least one memory and the computer program code configured to, with the at least one processor, cause the apparatus at least to perform: control obtaining from a computing device in a wireless manner information on an identifier related to a purchase session maintained by the computing device; control the transmission of the identifier to a first network server; control the reception of information from the first network server, the information related to the purchase session and comprising a request to acknowledge a purchase of the purchase session; control the transmission of a purchase acknowledgement to the first network server.

According to an aspect of the present invention, there is provided A network server apparatus, comprising: at least one processor; at least one memory including computer program code; the at least one memory and the computer program code configured to, with the at least one processor, cause the apparatus at least to perform: control the reception of information on a purchase session from a network vendor server; control the transmission of an identifier related to the purchase session to a the network vendor server; control the reception of the identifier from mobile user equipment; control the transmission of information related to the purchase session to the mobile user equipment; control the reception of payment information related to the purchase session from the mobile user equipment; and control the transmission of payment acknowledgement to the network vendor server.

According to another aspect of the present invention, there is provided a method in an apparatus, comprising: obtaining from a computing device in a wireless manner information on an identifier related to a purchase session maintained by the computing device; controlling the transmission of the identifier to a first network server; controlling the reception of information from the first network server, the information related to the purchase session and comprising a request to acknowledge a purchase of the purchase session; controlling the transmission of a purchase acknowledgement to the first network server.

According to another aspect of the present invention, there is provided a method in an apparatus, comprising: controlling the reception of information on a purchase session from a network vendor server; controlling the transmission of an identifier related to the purchase session to a the network vendor server; controlling the reception of the identifier from mobile user equipment; controlling the transmission of information related to the purchase session to the mobile user equipment; controlling the reception of payment information related to the purchase session from the mobile user equipment; and controlling the transmission of payment acknowledgement to the network vendor server.

### LIST OF DRAWINGS

Embodiments of the present invention are described below, by way of example only, with reference to the accompanying drawings, in which

FIG. 1 illustrates an example of a general operating environment applicable to some embodiments of the invention;

FIG. 2 illustrates an example of authentication;

FIG. 3 is a signalling chart illustrating an example embodiment;

FIG. 4 is a flowchart illustrating an embodiment of the invention;

FIG. 5 illustrates an example of an apparatus in which some embodiments of the invention may be applied;

FIG. 6 is a flowchart illustrating an embodiment of the invention;

FIG. 7 illustrates an example of an apparatus in which some embodiments of the invention may be applied and

FIGS. 8A to 8D illustrate examples of displayed information.

### DESCRIPTION OF SOME EMBODIMENTS

The following embodiments are only examples. Although the specification may refer to “an” embodiment in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

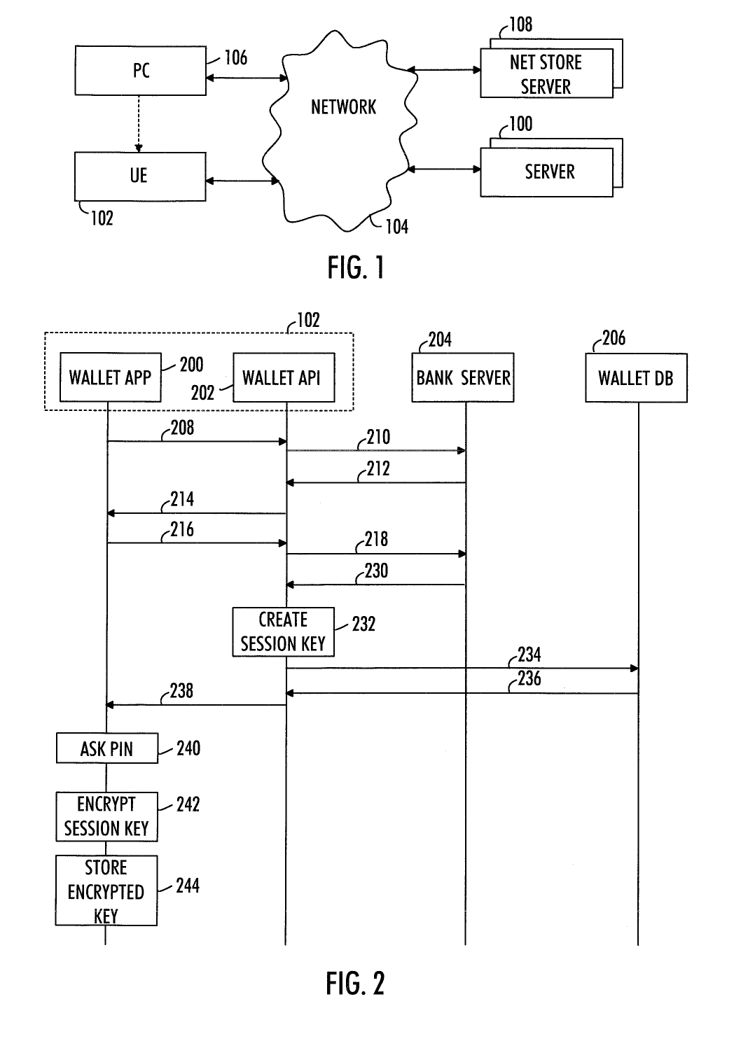

FIG. 1 illustrates an example of a general operating environment applicable to some embodiments of the invention. The environment comprises one or more network servers 100 running an authentication service and database operations, user equipment 102 running software, and a communication network 104 connecting the network server 100 and the user equipment 102.

The environment may further comprise a network retailer server 108 offering users the possibility to make purchases and a personal computing unit 106 connected to the network retailer server 108 via the communication network 104.

The communication network 104 may be a wired or wireless communication network or a combination of these. The network may include various wired/wireless standard, non-standard or proprietary communication networks such as a computer network, a private network, an IP-based network (TCP/IP=Transmission Control Protocol/Internet Protocol), the Internet, the telephone network including the public switched telephone network PSTN, any cellular network (such as a mobile phone network) such as GSM (Global System for Mobile Communications), GPRS (General Packet Radio Service), EGPRS (Enhanced GPRS), WCDMA (Wideband Code Division Multiple Access), UMTS (Universal Mobile Telephone System), 3GPP (The 3rd Generation Partnership Project), IMT (International Mobile Telecommunication), LTE (Long Term Evolution, LTE-A (LTE-Advanced), and other radio systems (in their present forms and/or in their evolution forms), a wireless local area network such as Wi-Fi or WLAN (Wireless Local Area Network) based on IEEE (Institute of Electrical and Electronics Engineers) 802.11 standard or its evolution versions or WiMAX (Worldwide Interoperability for Microwave Access, for example.

The communication networks connecting the user equipment and the servers 100 and the personal computing unit 106 and the network retailer server 108 may be at least in part different. For example, the personal computing unit 106 may be connected to a wired network and the user equipment to a wireless network. However, the nature of the network or networks is not relevant regarding the embodiments of the invention.

The personal computing device 106 may be a personal computer, a laptop computer, a tablet computer or any other computing device capable of connecting to a communications network 104, contacting the network retailer server 108 and displaying information.

The network retailer server or servers 108 may be a personal computer or a set of computers or a computer network or any other kind of processing system comprising a at least one processor; and at least one memory including computer program code.

User equipment 102 refers to a computing device. Such computing devices include wireless mobile communication devices operating with or without a subscriber identification module (SIM), including, but not limited to, the following types of devices: a mobile phone, a smartphone, a personal digital assistant (PDA), a tablet computer, a laptop or table top computer.

The network server or servers 100 may be configured to offer the user equipment 102 authentication service and database operations. The server or servers 100 may be a personal computer or a set of computers or a computer network or any other kind of processing system comprising a at least one processor; and at least one memory including computer program code. The server is configured to be accessible by users through the communication network 104, for example. The server may comprise suitable interfaces and/or transceivers to contact the communication network.

The user equipment 102 may run software configured to authenticate the user of the user equipment by communicating with the server 100. Let us denote the software as electronic wallet application. FIG. 2 is a signalling chart of an example of possible authentication procedure. It is to be noted, however, that the embodiments of the invention are not limited to the presented authentication example. Also other kind of authentication procedures may be applied as one skilled in the art is well aware.

The example of FIG. 2 illustrates signalling between the wallet application 200, wallet application programming interface (API) 202, a first network server 206 and a second network server 204 configured to perform authentication. The first network server 206 may be denoted as a bank server and second network server 204 may be denoted as a database server.

In an embodiment, the wallet application 200 and the wallet application programming interface (API) 202 are run by the user equipment 102.

In an embodiment, the server 204 performs authentication of the user of the wallet application so that the wallet application may access the database server 206 in a secure manner.

In this example, the authentication procedure begins by the wallet application 200 sending 208 user id and password to wallet API 202. The wallet application may be configured to query the user id and password when the application is initialized or when the application is connecting to network in response to a user action.

The wallet API 202 forwards 210 the user id and password to the authentication server 204.

The authentication server 204 checks the user id and password and if correct responds with a message 212 comprising an acknowledgement and a key code challenge.

Many services utilized over communication networks require authentication. Typically, authentication is realised using a username and a password. In more sophisticated solutions, key codes or key numbers are used in addition to username and password authentication. The user may have a key code list comprising a set of challenges and corresponding responses as number pairs. A server requiring authentication submits the user a challenge, and the user is required to find the challenge from the key code list, find the response corresponding the challenge and submit the response. The server grants access if the submitted response was correct.

The wallet API receives the message 212 and forwards 214 it to the wallet application 200. The wallet application receives a response to the key code challenge from the user and sends 216 it to the wallet API. The wallet API transmits 218 the response the authentication server 204. The server authenticates the response and sends an acknowledgement 230 to the wallet API.

At this phase the two-level authentication has been performed. The first level comprises the user id and password and the second level the key code challenge/response.

In an embodiment, to finalize the process, the wallet API creates 232 a session id and a session key for the current on-going session. In an embodiment, the session key is a 256 bit random number. However, this is merely an example. The API transmits 234 the session id and session key to the database server 206.

The database server 206 acknowledges 236 the session data.

The wallet API transmits 238 the session id and session key to the wallet application.

In an embodiment, the wallet application is configured to query 240 the user a PIN (personal identification number). The PIN is utilised to encrypt 242 the session key.

The wallet application is then configured to store 244 the encrypted session key but delete the PIN and plain session key from memory.

The session id and key may be used in communication with the database server 206 to identify the user and user equipment. If a session is interrupted or timed out, a new session key may be created

In an embodiment, the user equipment 102 may run software configured to enable the user of the user equipment to make payments related purchases from to network vendors. The payment procedure may be based on the authentication of the user and in communication with the bank server 204 and database server 206.

In an embodiment, the user is accessing a network vendor server 108 using a personal computing device 106 and making purchases in a purchase session. The database server 206 is configured to communicate with the network vendor server 108 and the user equipment 102 running wallet software and perform the payment operation related to purchases of the purchase session. Thus, a trusted purchase session between the network vendor server 108 and the personal computing device 106 is connected with an authenticated session between the user equipment 102 and the data base server 206.

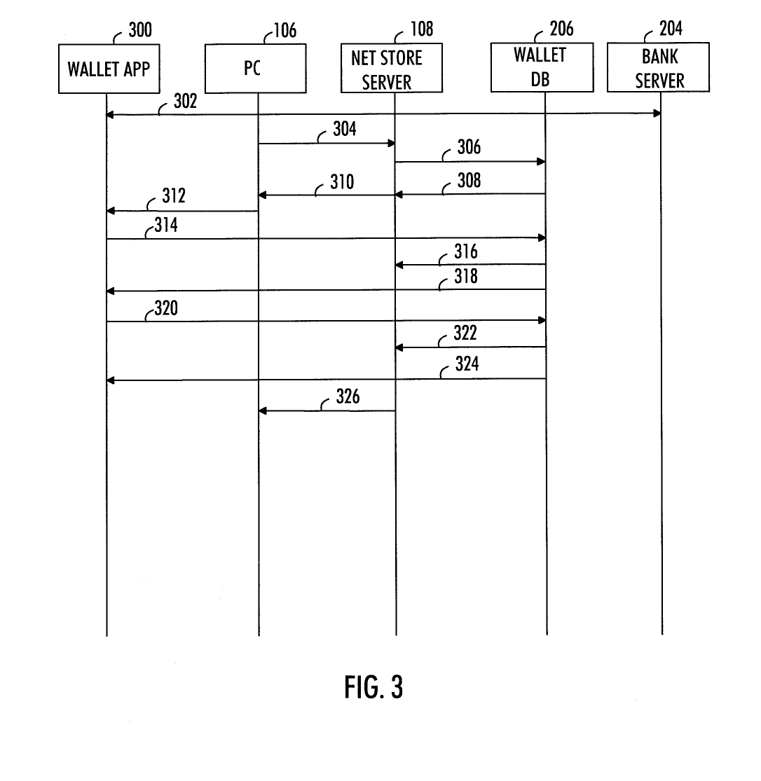

FIG. 3 is a signalling chart which illustrates an example embodiment of communication during a purchase payment procedure. The chart illustrates an example of communication between a wallet application software 300 run in user equipment 102, the personal computing device 106, the network vendor server 108, the wallet database server 206 and the bank server 204 when the user is making purchases from the network vendor server 108.

In an embodiment, the payment procedure may be made easy and convenient for the user by the wallet application software 300 run in the user equipment. The wallet application software is configured to create a trusted session with the wallet database server 206 by performing an authentication procedure 302 with a bank server. A non-limiting example of the authentication procedure is illustrated in the example of FIG. 2. The authentication procedure creates a trusted session between the wallet application software 300 and the database server 206.

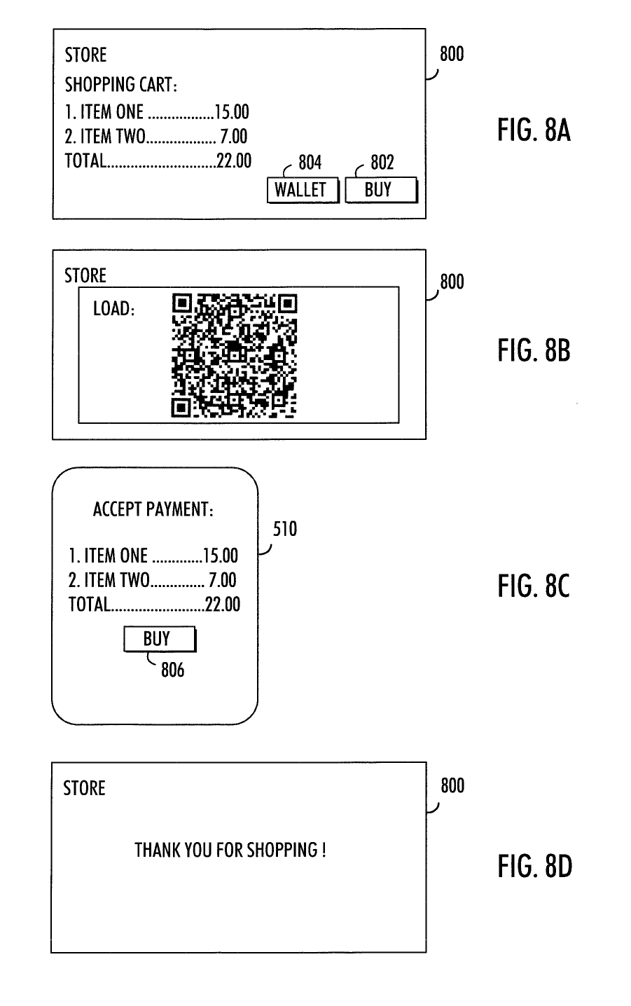

The user is performing a purchase from the network vendor server 108 in a purchase session maintained by the personal computing device 106. As illustrated in FIG. 8A, the network vendor server may present on the display 800 of the personal computing device a shopping cart of the purchase session. As payment options a credit card option 802 and wallet payment option 804 are presented.

In this example, the wallet payment option 804 is chosen by the user. The personal computing device 106 receives the selection and transmits a message 304 to the network vendor server 108 indicating that the wallet payment option is to be used.

The network vendor server 108 is configured to inform 306 the wallet database server 206 that wallet payment has been selected regarding the on-going purchase session.

The wallet database server 206 is configured to generate a unique identifier related to the purchase session and transmit 308 the identifier to the network vendor server 108 which transmits 310 the identifier to the personal computing device 106. In an embodiment, the identifier may be a random or pseudo random number generated by the wallet database server.

In an embodiment, the personal computing device 106 is configured to show the unique identifier on the display 800 of the personal computing device. In an embodiment, the identifier may be in a form easily readable by user equipment. An example of such an identifier is a Quick Response QR code as illustrated in FIG. 8B. The identifier may be shown together with an instruction to load the identifier to the wallet application software run in the user equipment.

A QR code is the trademark for a type of matrix barcode (or two-dimensional code) first designed for the automotive industry. The QR comprises black modules (square dots) arranged in a square pattern on a white background. The information encoded may be made up of four standardized modes of data (numeric, alphanumeric, byte/binary, Kanji), or through supported extensions, virtually any kind of data. The alphanumeric character codes of the QR code may include alphanumeric characters: numbers from “0” to “9”, alphabets from “A” to “Z” or “Ö” in Nordic languages, and “space”, “$”, “%”, “*”, “+”, “−”, “.”, “/”, “\”, “|”, {“, ”}”, “~”, “*” and “:” as special characters, for example.

The identifier may also be another type of barcode or code which is optically readable.

In an embodiment, the personal computing device 106 is configured to show an advertisement or promotion of the wallet application software on the display together with the QR code or barcode.

The user may initiate the wallet application software at this point and perform authentication if it has not been performed earlier.

The user may be prompted by the personal computing device to load the QR code or barcode shown on the display of the device using the wallet application software.

The wallet application software may be configured to control the camera of the user equipment to capture 312 the QR code or barcode from the display of the personal computing device.

After capturing the QR code or barcode the wallet application software may be configured to decode the identifier from the captured code and transmit 314 the identifier to the wallet database server 206 utilising the trusted session which had been authenticated beforehand.

The wallet database server 206 receives the identifier from the wallet application software and is configured to connect the session between the server and the wallet application software with the purchase session maintained by the personal computing device 106 with network vendor server 108. Thus, the wallet database server 206 may determine that the on-going purchase is being made by the user of the user equipment running the wallet application software.

The wallet database server 206 is configured to transmit 316 information on the identity of the purchaser to the network vendor server 108. In an embodiment, the identity is determined on the basis of the message from the wallet software application.

In an embodiment, the network vendor server 108 may transmit a cookie to the personal computing device 106 which is configured to store the cookie during the purchase session. A cookie is a small data item, which in this case identifies the identity of the purchaser.

The wallet database server 206 is configured to transmit 318 a confirmation of items to be purchased to the wallet application software and request payment. The wallet application software may be configured to show information on items to be purchased on the display of the user equipment 510 as illustrated in FIG. 8C along with a prompt 806 to execute the payment.

If indicated by the user of the user equipment the wallet application software is configured to transmit 320 confirmation of the payment to the wallet database server 206 which is configured to execute the payment.

The wallet database server 206 may transmit 322, 324 acknowledgement of the payment to the wallet application software 300 and network vendor server 108.

Upon receiving the acknowledgement the network vendor server 108 may be configured to transmit 326 a finalising message to the personal computing device 106. An example of the message is illustrated in FIG. 8D.

In an embodiment, if the purchaser makes another purchase during the same purchase session the use of an identifier sent by the wallet database server 206 may no longer necessary as the network vendor server 108 and the personal computing device 106 may determine the identity of the purchaser from the cookie generated by the network vendor server and stored in the personal computing device. However, otherwise the payment procedure may be similar to what is described above.

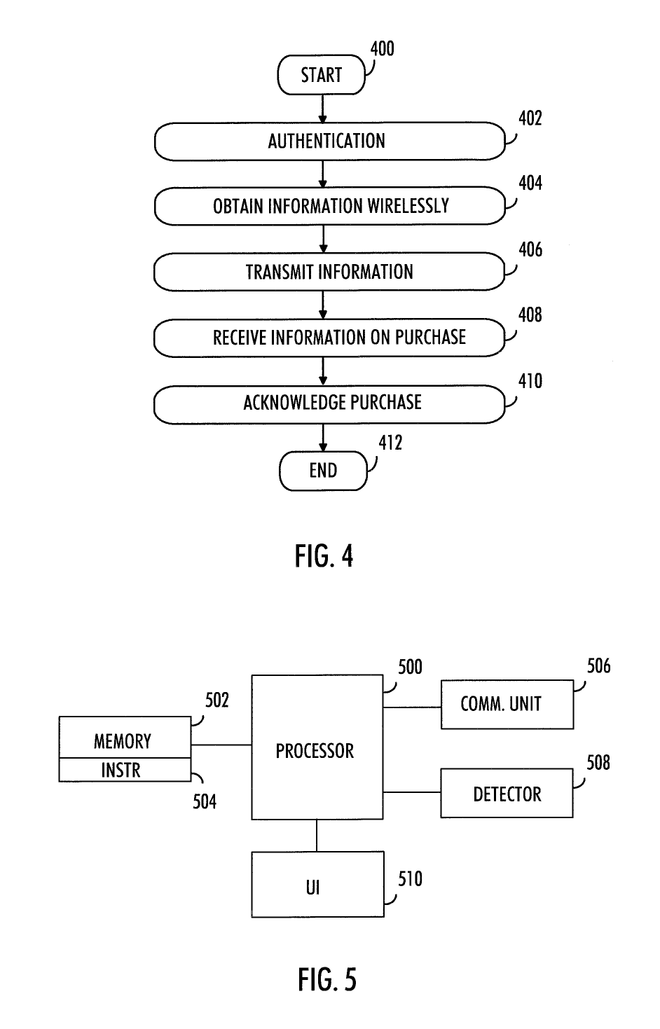

FIG. 4 is a flowchart illustrating an embodiment of the invention. The apparatus employing the embodiment may be user equipment 102 or a part of the user equipment, for example. The embodiment starts at step 400.

In step 402, the apparatus 102 is configured to execute wallet application and perform authentication. The authentication may be performed as described in connection with FIG. 2, for example.

In step 404, the apparatus is configured to control a detector to obtain from a personal computing device in a wireless manner information on an identifier related to a purchase session maintained by the computing device. In an embodiment, the apparatus comprises a camera. The user may point the camera to the screen of the personal computing device and the apparatus may be configured to read the QR code on the display.

In step 406, the apparatus is configured to control the transmission of the information to a first network server or a database server.

In step 408, the apparatus is configured to control the reception of information from the first network server, the information related to the purchase session and comprising a request to acknowledge a purchase of the purchase session.

In step 410, the apparatus is configured to control the transmission of a purchase acknowledgement to the first network server or the database server.

The process ends in step 412.

FIG. 5 illustrates an embodiment. The figure illustrates a simplified example of a device in which embodiments of the invention may be applied. In some embodiments, the device may be user equipment UE or a respective device communicating with a communications network. In some embodiments, the device may be a part of user equipment or a respective device. In general, device may be a computing device, including wireless mobile communication device operating with or without a subscriber identification module (SIM), including, but not limited to, the following types of devices: a mobile phone, a smartphone, a personal digital assistant (PDA), a tablet computer, a laptop or table top computer.

It should be understood that the apparatus is depicted herein as an example illustrating some embodiments. It is apparent to a person skilled in the art that the device may also comprise other functions and/or structures and not all described functions and structures are required. Although the device has been depicted as one entity, different modules and memory may be implemented in one or more physical or logical entities.

The device of the example includes a control circuitry 500 configured to control at least part of the operation of the device.

The device may comprise a memory 502 for storing data. Furthermore the memory may store software 504 executable by the control circuitry 400. The memory may be integrated in the control circuitry.

The device may comprise a transceiver 506. The transceiver is operationally connected to the control circuitry 500. It may be connected to an antenna arrangement (not shown).

The software 504 may comprise a computer program comprising program code means adapted to cause the control circuitry 400 of the device to control a transceiver 506.

The device may further comprise user interface 510 operationally connected to the control circuitry 500. The user interface may comprise a display which may be touch sensitive, a keyboard or keypad (which may be implemented using a touch sensitive display), a microphone and a speaker, for example.

The control circuitry 500 is configured to execute one or more applications. The applications may be stored in the memory 502. The applications may generate data traffic with the system. The applications may require data from a server in the Internet or they may store data in the server. In general the traffic generated by applications may be periodic or continuous or something in between.

In an embodiment, the device comprises at least one detector unit 508. The detector unit may be a camera configured to capture images. The software 504 may comprise a computer program comprising program code means adapted to cause the control circuitry 500 of the device to control the at least one detector unit 508.

Some of the above mentioned units might be accessories connectable to a device.

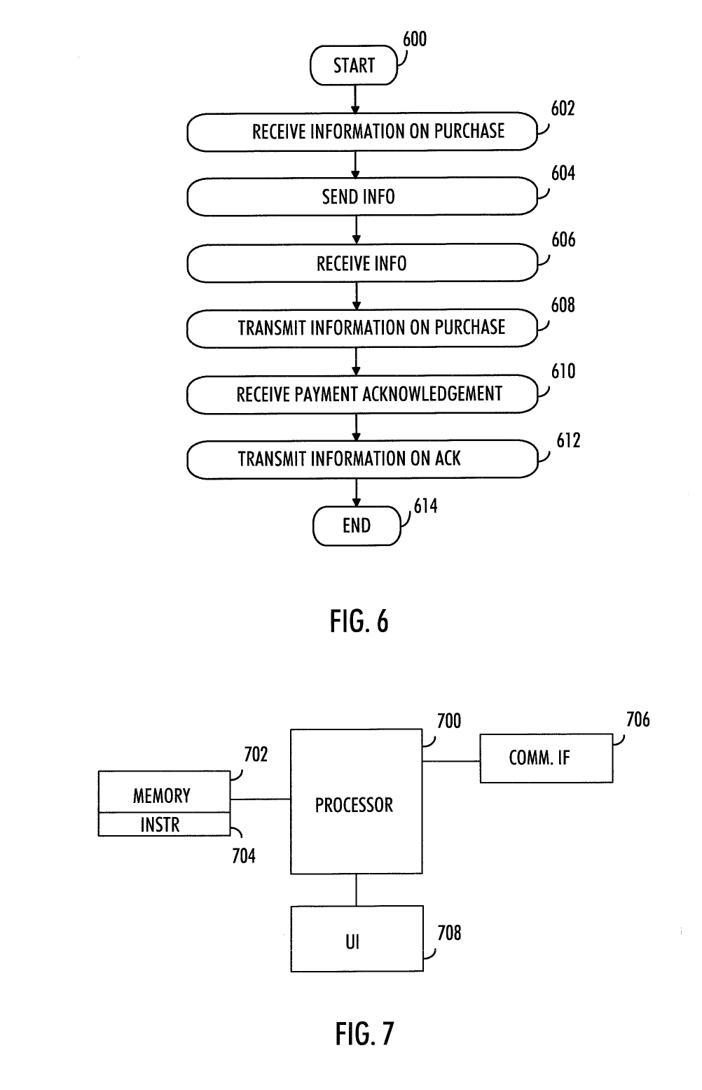

FIG. 6 is a flowchart illustrating an embodiment of the invention. The apparatus employing the embodiment may be a server 206 or a part of the server, for example. The embodiment starts at step 600.

In step 602, the apparatus 206 is configured to control the reception of information on a purchase session from a network vendor server.

In step 604, the apparatus 206 is configured to control the transmission of an identifier related to the purchase session to the network vendor server.

In step 606, the apparatus 206 is configured to control the reception of the identifier from mobile user equipment;

In step 608, the apparatus 206 is configured to control the transmission of information related to the purchase session to the mobile user equipment.

In step 610, the apparatus 206 is configured to control the reception of payment information related to the purchase session from the mobile user equipment.

In step 612, the apparatus 206 is configured to control the transmission of payment acknowledgement to the network vendor server. In an embodiment, the apparatus is configured to also control the transmission of payment acknowledgement to the mobile user equipment.

The process ends in step 614.

FIG. 7 illustrates an embodiment. The figure illustrates a simplified example of a device in which embodiments of the invention may be applied. In some embodiments, the device may be a server 206 of FIG. 2 maintaining a database and communicating with user equipment UE or respective devices via a communications network. In some embodiments, the device may be a part of a server or a respective device. In general, device may be a computing device including, but not limited to, the following types of devices: a personal computer, a server computer.

It should be understood that the apparatus is depicted herein as an example illustrating some embodiments. It is apparent to a person skilled in the art that the device may also comprise other functions and/or structures and not all described functions and structures are required. Although the device has been depicted as one entity, different modules and memory may be implemented in one or more physical or logical entities.

The device of the example includes a control circuitry 700 configured to control at least part of the operation of the device.

The device may comprise a memory or an interface 702 to a memory for storing data. Furthermore the memory may store software 704 executable by the control circuitry 700. The memory may be integrated in the control circuitry.

The device may comprise a communication interface 706. The communication interface is operationally connected to the control circuitry 700. The interface may provide the device a connection to a communication system. The connection may be wired or wireless. The interface may be a network interface card, a transceiver or any other kind of apparatus providing network connections.

The software 704 may comprise a computer program comprising program code means adapted to cause the control circuitry 700 of the device to control the communication interface 706.

The device may further comprise user interface 708 operationally connected to the control circuitry 700. The user interface may comprise a display which may be touch sensitive, a keyboard or keypad, for example.

The control circuitry 700 is configured to execute one or more applications. The applications may be stored in the memory 702. The applications may generate data traffic with the system. The applications may require data from a server in the Internet or they may store data in the server. In general the traffic generated by applications may be periodic or continuous or something in between.

Some of the above mentioned units might be accessories connectable to a device.

The steps and related functions described in the above and attached figures are in no absolute chronological order, and some of the steps may be performed simultaneously or in an order differing from the given one. Other functions can also be executed between the steps or within the steps. Some of the steps can also be left out or replaced with a corresponding step.

The apparatuses or controllers able to perform the above-described steps may be implemented as an electronic digital computer, or a circuitry that may comprise a working memory (RAM), a central processing unit (CPU), and a system clock. The CPU may comprise a set of registers, an arithmetic logic unit, and a controller. The controller or the circuitry is controlled by a sequence of program instructions transferred to the CPU from the RAM. The controller may contain a number of microinstructions for basic operations. The implementation of microinstructions may vary depending on the CPU design. The program instructions may be coded by a programming language, which may be a high-level programming language, such as C, Java, etc., or a low-level programming language, such as a machine language, or an assembler. The electronic digital computer may also have an operating system, which may provide system services to a computer program written with the program instructions.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

An embodiment provides a computer program embodied on a distribution medium, comprising program instructions which, when loaded into an electronic apparatus, are configured to control the apparatus to execute the embodiments described above.

The computer program may be in source code form, object code form, or in some intermediate form, and it may be stored in some sort of carrier, which may be any entity or device capable of carrying the program. Such carriers include a record medium, computer memory, read-only memory, and a software distribution package, for example. Depending on the processing power needed, the computer program may be executed in a single electronic digital computer or it may be distributed amongst a number of computers.

The apparatus may also be implemented as one or more integrated circuits, such as application-specific integrated circuits ASIC. Other hardware embodiments are also feasible, such as a circuit built of separate logic components. A hybrid of these different implementations is also feasible. When selecting the method of implementation, a person skilled in the art will consider the requirements set for the size and power consumption of the apparatus, the necessary processing capacity, production costs, and production volumes, for example.

In an embodiment, the apparatus may also be implemented as an apparatus comprising means for receiving a challenge from a network server; means for controlling a detector to obtain wirelessly from an external object information on challenge/response pairs; means for determining a response to the challenge on the basis of the obtained information; and means for transmitting the response to the network server.

It will be obvious to a person skilled in the art that, as technology advances, the inventive concept can be implemented in various ways. The invention and its embodiments are not limited to the examples described above but may vary within the scope of the claim.

1-11. (canceled)

12. An apparatus, comprising:
at least one processor;
at least one memory including computer program code;
the at least one memory and the computer program code configured to, with the at least one processor, cause the apparatus at least to perform:
perform authentication with a second network server to initialise a trusted session between the apparatus and first and second network server;
control obtaining after authentication from a computing device in a wireless manner information on an identifier related to a purchase session maintained by a network vendor server via the computing device;
control the transmission of the identifier to a first network server;
control the reception of information from the first network server, the information related to the purchase session and comprising a request to acknowledge a purchase of the purchase session;
control the transmission of a purchase acknowledgement to the first network server.

13. The apparatus of claim 12, the apparatus comprising a camera; and the at least one memory and the computer program code being configured to, with the at least one processor, cause the apparatus further to perform:
control the camera to photograph a graphical code being on an object external to the apparatus; and
decode information related to the purchase from the graphical code.

14. The apparatus of claim 12, further comprising user interface, the at least one memory and the computer program code being configured to, with the at least one processor, cause the apparatus further to perform:
control the reception of a verification of the reception of the acknowledgement from the first network server.

15. The apparatus of claim 12, further comprising user interface, the at least one memory and the computer program code being configured to, with the at least one processor, cause the apparatus further to perform:
after receiving information related to the purchase session control the user interface to display the information and receive purchase acknowledgement.

16. A network server apparatus, comprising:
at least one processor;
at least one memory including computer program code, and
the at least one memory and the computer program code configured to, with the at least one processor, cause the apparatus at least to perform:
control the reception of session information from a second network server regarding a trusted session with a mobile user equipment authenticated by the second network server;
control the reception of information on a purchase session from a network vendor server after receiving session information;
control the transmission of an identifier related to the purchase session to a the network vendor server;
control the reception of the identifier from mobile user equipment;
control the transmission of information related to the purchase session to the mobile user equipment;
control the reception of payment information related to the purchase session from the mobile user equipment; and
control the transmission of payment acknowledgement to the network vendor server.

17. The apparatus of claim 16, the at least one memory and the computer program code configured to, with the at least one processor, cause the apparatus at least to perform:
control the transmission of payment acknowledgement to the mobile user equipment.

18. A method in an apparatus, comprising:
performing authentication with a second network server to initialise a trusted session between the apparatus and first and second network server;
obtaining from a computing device after authentication in a wireless manner information on an identifier related to a purchase session maintained by a network vendor server via the computing device;
controlling the transmission of the identifier to a first network server;
controlling the reception of information from the first network server, the information related to the purchase session and comprising a request to acknowledge a purchase of the purchase session;
controlling the transmission of a purchase acknowledgement to the first network server.

19. A method in an apparatus, comprising:
controlling the reception of session information from a second network server regarding a trusted session with a mobile user equipment authenticated by the second network server
controlling the reception of information on a purchase session from a network vendor server after receiving session information;
controlling the transmission of an identifier related to the purchase session to a the network vendor server;
controlling the reception of the identifier from mobile user equipment;
controlling the transmission of information related to the purchase session to the mobile user equipment;
controlling the reception of payment information related to the purchase session from the mobile user equipment; and
controlling the transmission of payment acknowledgement to the network vendor server.

20. A computer readable storage medium comprising one or more sequences of one or more instructions which, when executed by one or more processors of an apparatus, cause the apparatus to perform the steps of
performing authentication with a second network server to initialise a trusted session between the apparatus and first and second network server;
obtaining from a computing device after authentication in a wireless manner information on an identifier related to a purchase session maintained by a network vendor server via the computing device;
controlling the transmission of the identifier to a first network server;
controlling the reception of information from the first network server, the information related to the purchase session and comprising a request to acknowledge a purchase of the purchase session;
controlling the transmission of a purchase acknowledgement to the first network server.

21. A computer readable storage medium comprising one or more sequences of one or more instructions which, when executed by one or more processors of an apparatus, cause the apparatus to perform the steps of:
controlling the reception of session information from a second network server regarding a trusted session with a mobile user equipment authenticated by the second network server
controlling the reception of information on a purchase session from a network vendor server after receiving session information;
controlling the transmission of an identifier related to the purchase session to a the network vendor server;
controlling the reception of the identifier from mobile user equipment;
controlling the transmission of information related to the purchase session to the mobile user equipment;
controlling the reception of payment information related to the purchase session from the mobile user equipment; and
controlling the transmission of payment acknowledgement to the network vendor server.
